(19) United States
(12) Patent Application Publication
(10) Pub. No.: US 2025/0051083 A1
(43) Pub. Date: Feb. 13, 2025

(54) AN INSULATING TRANSPORT AND STORAGE CONTAINER, METHOD AND MATERIAL ASSOCIATED

(71) Applicant: Softbox Systems Limited, Long Crendon (GB)

(72) Inventors: Padraic Thomas O'Hara, Long Crendon (GB); James Nathan Jarvis, Long Crendon (GB)

(21) Appl. No.: 18/721,951

(22) PCT Filed: Jan. 2, 2023
(86) PCT No.: PCT/EP2023/050031

§ 371 Date: Jun. 20, 2024

(30) Foreign Application Priority Data
Dec. 24, 2021 (GB) 2119036.8
Dec. 28, 2022 (GB) 2219799.0

(51) Int. Cl. B65D 81/38; B32B 3/30; B32B 27/10; B32B 27/32; B32B 29/00; B32B 29/08; B65D 53/02; B65D 65/40

(52) U.S. Cl. CPC B65D 81/3862; B32B 3/30; B32B 27/10; B32B 27/32; B32B 29/005; B32B 29/08; B65D 53/02; B65D 65/403; B32B 2255/12; B32B 2255/205; B32B 2307/304; B32B 2307/718; B32B 2439/62; B65D 2251/205; B65D 2565/385

(57) ABSTRACT

The invention relates to the field of the transportation and storage of goods and, in particular, to a box or box-like transport container that can provide a high degree of thermal insulation. More particularly, the present invention relates to storage containers that comprise a box or box-like container that can be hand-held. In the field of logistics, there is a widespread requirement to protect a thermally sensitive load to ensure that certain types of produce and materials do not to pass through certain temperature thresholds. It is well known that, for example, vegetables when subject to extremes of temperature that they become flaccid, as the cell structure is broken down through the formation of icicles or through dehydration. The present invention seeks to provide a container having a construction formed from recyclable materials that have similar or better thermal properties to known materials such as expanded polystyrene.

### FIELD OF INVENTION

The present invention relates to the field of the transportation and storage of goods and, in particular, to a carton, box or box-like transport container that can provide a high degree of thermal insulation. More particularly, but not necessarily restricted thereto, the present invention relates to storage containers that comprise a box or box-like container that can be hand-held. The present invention also relates to an increasing requirement for single use containers where, in particular, they can be economically manufactured, need not be returned to sender and are widely and simply recyclable, without costly removal of components.

### BACKGROUND TO THE INVENTION

In the field of logistics, that is the field of movement and supply of produce and materials, there is a widespread requirement to protect a thermally sensitive load to ensure that certain types of produce and materials do not to pass through certain temperature thresholds. It is well known that, for example, vegetables when subject to extremes of temperature that they become flaccid, as the cell structure is broken down through the formation of icicles or through dehydration. In the transport of pharmaceuticals, goods are rejected if temperature records show out of range excursions, meaning that losses can have a serious consequence with provision of medical care, additionally, financial losses can be considerable.

In essence, in any transport container with a thermally sensitive load, the rate at which heat passes through the packaging material of the transport container—the amount of heat that flows per unit time through a unit area with a temperature gradient per unit distance must not extend beyond a permitted temperature range for the product. The lambda value (λ-value)—sometimes referred to as a ‘K-value’—refers to a material's thermal conductivity in units of W/m·K. A good insulator will have as low a lambda value as possible to reduce heat loss. By dividing a material's thickness (in metres) by its lambda value, you can discover how well it resists heat transfer at a specific thickness—its ‘R-value’. A product's R-value measures its thermal resistance in units of m²·K/W. Accordingly, better insulators will have a higher R-value at lower thicknesses, indicating that it is just as good at reducing heat loss as some of its slightly thicker but lower insulating alternatives. Vacuum Insulation Panels (VIPs) have been developed which provide a very low thermal conductivity value (<5 mW/m·K) which prevent heat flow into or out of a thermal package. Nonetheless, given that they effectively comprise a plastics bag that is filled with particles of a low conductivity media such as silica and carbon, which bags are evacuated and then sealed need to be protected from mishandling, to prevent the plastics bags from being ripped and cut, whereby to destroy the vacuum therewithin; moreover they are expensive to manufacture.

Temperature control of thermally sensitive goods is particularly challenging when the thermally sensitive goods must be maintained within a narrow temperature range. Two factors are key issues in the maintenance of a temperature time balance each other over a period of time: thermal generation i.e. heating or refrigeration within a carton or container and thermal transfer i.e. loss or gain of heat to or from the carton or container with respect to its surrounding atmosphere—which can vary from the atmosphere of a packing trolley on an airport runway/gate to a thermal transfer with abutting cartons on the back of a lorry or storeroom. Thermal generation or control requires a cooling or heating agent to balance thermal loss through heat exchange of a container with its surrounding atmosphere, be it similar containers, truck space or otherwise. Active refrigeration units as used on certain trucks and containers require a source of electrical power or a fuel for a gas-powered air-conditioning/freezer unit and also require an atmosphere with which to exchange heat and as a source of oxygen for a gas powered air-conditioning/freezer unit as well accept exhaust gasses. Such refrigeration units not only occupy a volume, they cannot be used for small containers and individual boxes.

Passive thermal generation units rely upon a body or bodies having a high thermal capacity which exchange energy with the goods to compensate for thermal energy transfer. Typical means for shipping temperature sensitive materials involves the use of an insulated box, with the necessary shipping and warning labels, along with some thermal energy transfer agent. These thermal energy transfer agents have typically been, for example, a frozen gel, dry ice, water-based ice or other phase change materials, placed within an insulator packing agent, such as cotton or, latterly, plastics materials such as expanded polystyrene foam, wherein heat is absorbed by such cooling agents. Thermal control units add to the weight of a carton or container and therefore increases transport costs.

Low cost temperature control in the transport industry often relies upon a number of layers of plastics foam to retain an inside temperature subject to the thermal path to a transported product from an outside the outside to maintain ideal operating temperature, as disclosed in WO02085749 in the name of the present applicant. WO02085749 teaches of a transport container which comprises of a substantially rigid liner, with flexible plastics foam surrounding the liner, and two substantially rigid plugs insertable at either end inside the liner to retain the liner in a non-collapsed configuration whereby to hold transportable contents therein. Polyethylene foam is not rigid and necessitates an encasement or be otherwise supported by way of a secondary rigid element. Furthermore, a significant issue in today's emphasis on the use of products that can be readily be recycled is that polyethylene, without special treatment, is not readily biodegradable, and thus accumulates in landfill etc., Expanded polystyrene is an extremely good insulator and is also widely used. However, it is notoriously difficult to dispose of; it becomes friable with age and breaks down into small particles, which particles are difficult to collect and can be widely dispersed by the wind. Floating Marine Debris (FMD) is litter that ends up in the seas and other large bodies of water and is becoming an increasing problem. The Great Pacific Garbage Patch is a collection of FMD in the North Pacific Ocean. In one study, observed FMD consisted mainly of plastic material (86.9%).

Numerous insulated shipping containers have been developed over the years, with those deploying a packaged phase change material (PCM) generally providing superior temperature control over extended periods. Insulated shipping containers employing a PCM coolant can be deployed for a wide range of thermally sensitive goods over a wide range of target temperatures by using different PCMs. For example, deuterium oxide melts at +4° C., water melts at 0° C., a 20% ethylene glycol solution melts at −8° C., neat ethylene glycol melts at −12.9° C., mineral oil melts at −30° C., and a 50% ethylene glycol solution melts at −37° C. This permits use of insulated shipping containers for a broad range of thermally labile goods, with the PCM coolants being capable of re-used hundreds of times. Healthcare packaging solutions are necessarily validated to international standards and are over-specified to cope with isolated but inevitable delays. It will be noted that the amount of coolants supplied per transport journey or other instance of use are determined with regard to anticipated geographical weather ambient conditions and storage facility ambient conditions for the cold chain logistics product. Whilst these phase change container systems can work well, they are relatively expensive to purchase. Furthermore, the phase change material suffers from not being particularly degradable, which issue is reflected in the use of conventional prior containers where polystyrene and polyethylene foams, as used for insulation, do not degrade readily, leading to similar disposal problems.

Nonetheless, when low temperatures are required coolant systems other than “normal” phase change material are required. Indeed, there is an increasing need for 48 hour delivery cartons, meaning that the cartons must be sufficient to enable thermally labile goods to remain within a prescribed temperature range and have sufficient temperature maintenance capacity to permit delays due to unforeseen issues not to have a detrimental effect on the goods themselves, with an over-specification of up to 30% sometimes being deemed necessary.

An alternative to the use of phase change coolants, packaged for re-use in containers, are certain gasses (at Standard Temperature and Pressure (STP)) such as carbon dioxide and nitrogen. These gasses have become useful for their sublimation and evaporative properties-typically solid carbon dioxide, which is ordinarily referred to as dry ice in the solid state and which sublimates at −78.5° C. under normal atmospheric pressure. Dry ice is classified as being potentially dangerous in view of the fact that carbon dioxide gas evolved during shipment can be dangerous to shipping personnel, necessitating the use of hazard warnings, protective gear and, sometimes, the payment of additional transport fees. However, especially in the pharmaceutical cold chain industry, there is a need for containers that can maintain goods below −20° C. Consequentially, dry ice is frequently being used for such pharmaceutical transport and the like and there is an increasing need to ensure that the containers and cartons therefor have extremely low coefficients of thermal conductivity. With reference to FIG. 1, there is shown a graph of phase diagrams of carbon dioxide (dashed line) and water (dotted line) showing the carbon dioxide sublimation point (middle-left) at 1 atmosphere. As dry ice is heated, it crosses this point along the bold horizontal line from the solid phase directly into the gaseous phase. Water, on the other hand, passes through a liquid phase at 1 atmosphere. As a rule of thumb, for a carton expect a half Kilogramme of dry ice to sublimate every 24 hours. However, the exact sublimation rate will depend on the quality of the insulation provided. The lower the level of insulation, the faster the rate of sublimation—and this is factored into any determination of the amounts of dry ice that are required for any period of time of transport and storage, taking into account the varying needs of the goods, whether they be placed outside on a ground support vehicle on, for example, Miami airport on a summer's day or in the hold of an aircraft thousands of metres in the sky.

In addition to the increasing use of dry ice and their corresponding relatively high value containers in vaccine distribution, there is an increase of e-grocery in today's world and online shopping is a growing phenomenon in view of the saving of time and general convenience. Major players in the e-grocery landscape differentiate themselves by the types of products and services they offer, particularly, by their method of order fulfilment and delivery and by the geographical markets in which they operate. Moreover, at time of an incidence of a health issue—presently the C-19 pandemic—there is a reduced ability to purchase goods at shops with enforced distancing and the wearing of masks to limit airborne particle transmission of any virus-laden respiratory droplets and aerosols that can lead to infection. Accordingly, there is an increasing need of cold chain transport and associated with this, there is a need to reduce the cost and improve the efficiency of insulating materials for cold chain the containers, whilst attending to the associated issues of recyclability and need for reducing produce and packaging wastage.

### OBJECT OF THE INVENTION

The present invention seeks to provide a solution to the problems addressed above. The present invention seeks to provide a sheet material that can be used in the construction of cold chain packages and containers having a composition that is easily recyclable. The present invention seeks to provide a container having a construction formed from recyclable materials that have similar or better thermal properties to known materials such as expanded polystyrene. The present invention further seeks to provide a thermally stable container that can provide a simple passive arrangement for use with and without phase change materials can enable goods to reliably be maintained within a particular temperature range. The present invention also seeks to provide a temperature controlled transport/storage assembly for goods in cartons and containers and pallet-borne goods or otherwise, whereby goods can be maintained within an atmosphere having a predefined temperature range.

### STATEMENT OF INVENTION

In accordance with a general aspect of the invention, there is provided a thermally insulating transport/storage container for transporting/storing temperature sensitive materials wherein the container is manufactured from three dimensional laminated recyclable sheet materials or at least substantially recyclable materials and a thermally insulating three dimensional laminated recyclable sheet material.

Thus, in a first aspect, the present invention provides a three dimensional insulating sheet material comprising at least a first thin film sheet and a second three-dimensional thin film sheet, the three dimensional configuration comprising an array of dimples or undulations with the layers coupled together whereby to define a high level of thermal resistance. This composite sheet material is usefully employed in multiple-layer applications whereby to provide wound packages that can enclose product to maintain a temperature or to substantially reduce a change in temperature through heat transfer. In tests, this material has provided equivalent and improved thermal performance relative to expanded polystyrene (EPS) with lambda values in correspondence.

Conveniently, the lightweight film comprises at least a first thin film sheet and a second three-dimensional thin film, which composite film is arranged as a wound sheet, about a product or a product receptacle, each subsequent sheet surrounding a previous sheet. A third thin film sheet may be applied to provide a closed cell structure; equally a further three dimensional sheet could be utilised, but the simplicity of the use of two or three sheet composites are easier to manage in fabrication procedures. Conveniently, the lightweight film sheet is metallized, whether just one sheet or all sheets. It has been found adequate for just one film of a composite film to be metallicized. Applicants have tended to utilize cellulose fibre material, in particular, wood fibre in view of the widespread availability of wood and the widespread and known recyclability of such, noting that the application of a metallic coating-if thin enough (e.g. of the order of an Angstrom or so in thickness) does not necessarily compromise recycling.

Thus, in a second aspect, the present invention provides an insulating transport/storage container for transporting/storing temperature sensitive materials, the container comprising: a central body defining a load volume and having at least one aperture and a closure therefor, the central body having an axis; at least one closure operable to close the at least one aperture; and, fastening means operable to secure said closure; wherein the central body comprises multiple-layers of lightweight film comprising at least a first thin film sheet and a second three-dimensional thin film sheet, with the layers coupled together whereby to define a high level of thermal resistance; and, wherein, upon securement by way of the fastening means, the closure is brought together with respect to the at least one aperture about mutually contacting areas. Conveniently, the closure provided has an equivalent level of thermal resistance to the body, to ensure uniform heat retention about the whole of the body. Conveniently, the inside walls of the central body are defined by an insert member of card or similar material to assist in providing a useful volume, such as in the form of a tubular element. The fastening means can comprise one or more of: adhesive tape, tensioned straps, shrink-wrap plastics film, a frame, and a box, wherein the fastening means is operable to ensure that the closure elements fit closely to/abut with the inside walls of the enclosure. The present invention thus provides a simple to manufacture self-supporting enclosure arrangement of insulating material to provide a container with very high insulation properties—both in a thermal sense and mechanical shock sense.

The load receiving element may comprise a tubular element having an axis which presents two apertures either end and each of the two apertures can be closed by a closure element, each closure element having a number of layers in correspondence with the number of layers of insulating material surrounding the tubular element, whereby to provide a corresponding level of thermal insulation about the load. Each of or only one of the closure elements or end caps can further define a generally conical or pyramidical plug (or frusto-conical or frusto-pyamidical) which are operable to fit in an interference fashion with an inside surface of the respective ends of the tubular wall section. The tubular element may be closed at one end, which closed end is provided with a number of layers of insulating material in correspondence with the side walls and open enclosure to pride a similar level of insulation about the product, in use.

In one embodiment, at least one of the first and second closures caps is arranged to closely abut the side edges of the windings of the respective first and second ends of the tubular element. This has the advantage of ensuring that gaseous transfer from outside of the container to within is effectively non-existent, although a pressure differential arising from sublimation of dry ice within is permitted; whilst adhesive tape or similar could also be provided about the edges defining the aperture either end of the tubular cylinder, the walls of the container would be less amenable to being compressed for storage or otherwise.

Preferably, the at least one closure is arranged such that a first, inner part has a section that corresponds with an inside section of the tubular wall element associated with one of the apertures and a second, outer part that has a profile that is arranged to provide thermal insulating properties. This has an advantage in that the inside volume of the tube is positively defined. It will be appreciated that the inside shape can be circular, elliptical or polygonal, with closure members of a corresponding shape. In another embodiment, the at least one closure is arranged such that said second, outer part of said closure is arranged such that its section profile corresponds with an external section of the tubular wall element whereby to provide an equivalent thermal conductivity.

The present invention can provide a simple to manufacture, low-cost container, carton or box for pharmaceutical deliveries, especially in the −20° C. delivery businesses. The wound or rolled insulation can be conveniently packed within a box, the lids of the box being arranged to help ensure integrity of the caps or bungs place at either end of the tubular arrangement. Indeed, in a further embodiment, the three-dimensional, multi-layered insulated sheet tubular wall member could be provided with two or more sections along its axial length where the number of layers of three-dimensional, multi-layered insulated sheet in these two or more sections differ, whereby the R-value would vary along the axial length. This could provide an advantage in that, with regard to home delivery of grocery items, temperature sensitive products such as ices could be placed within a sub-zero compartment; whilst temperature sensitive salad produce is separated in a different temperature zone. It will be appreciated that such a container can be employed in door-step delivery systems. Data tracking systems could be employed to provide advice of delivery and with regard to security/peace of mind to intended recipient. Temperature sensors could be provided to indicate an inside temperature of the contents.

The manufacture of the present invention can be as simple as cutting a roll of insulating sheet material to a specific width and using such width of material in surrounding a former—which may be of numerous shapes; rectangular (including square), triangular and other polygons, realizing that the closure element in the form of a bung—which can be made from numerous materials in principle and needs to be of a corresponding dimension so as to provide a friction fit and have a similar conductivity value—can easily and simply be made of the same material as the walls of the container.

The three-dimensional insulating sheet material can be arranged as a roll of material and, once cut to the correct dimensions, be taped or adhesively secured in position with respect to a first layer or to a cardboard former. The closure element can comprise an insert part with external axial dimensions in general correspondence with the inside of the axial tube, which is conveniently attached, again by tape or adhesive to a second, external part that protrudes beyond the axial dimensions of the tubular member, which external member has a shape that extends to the external dimensions of the tubular member. In an alternative, the width of the insulating material may extend beyond the length of the load volume, to permit the ends to be folded, crimped or other fastened, yet extend sufficiently to provide an equivalent degree of insulation but also be simply formed. Finally an external carton can enclose the wound and stoppered—or otherwise closed—insulating material, being one of, for example, cardboard or a plastics bag of sufficient thickness to provide a degree of protection to the payload.

Notwithstanding the problems encountered by known systems which employ phase change materials for short-term use, it will be realised the present invention will also benefit in terms of duration of temperature control the use of phase change material temperature control packs that include one or more phase change materials, are contained in sealed containers can be provided to further increase a period of time within which temperature stability can be achieved. The sealed containers for phase change materials can be provided by one of a plastics bag, a blister pack, a sheet cellulose package, a sealed polymer enclosure. The temperature control packs can be configured to provide a defined thermally stable atmosphere within the payload volume for a number of days as is typical for international travel, for example. The phase change material could also be arranged to be installed in cut-outs defined with the walls of the container, or between layers of corrugated material. In the event that dry ice is employed, then provision needs to be made for off-gassing, since dry ice sublimates, which can conveniently be provided by a pressure relief valve.

In accordance with another aspect of the invention, there is provided a method of packing a product for shipment comprising the steps of:
a. defining an axial load volume by wrapping three dimensional thin film material in accordance with the invention;
b. placing a first closure element at a first end of the tubular container element, such that an insert member is inserted within the tubular element without gaps as between an inside lining of the tube and the sides of the insert member;
c. placing product within tubular load volume;
d. placing a second closure element at a second end of the tubular container element, so as to close the tubular load volume; and
e. fastening the tubular member with respect to the first and second members by the use of adhesive fastening means, such as tape (adhesive or otherwise), straps, adhesives, shrink wrap materials or placement within a large box being dimensioned to prevent axial movement/separation of the closure members with respect to the axial tube. The method will vary with each specific form of construction. For example, an assembly apparatus can be arranged so as to dispense with an insert former. Additionally, the order of steps b) and c) above could be interchanged. By performing the operation within a room or area having a defined temperature, with products at the defined temperature or at a distinct separate temperature, a temperature of the load can be determined for a number of hours, given knowledge of anticipated temperatures outside of the container, as is known in the art of temperature controlled logistics.

The method may be supplemented by the provision of a temperature control pack with, for example, a phase change material or dry ice container whereby to enable a longer duration of temperature control, with regard to the size of the container, and expected ambient conditions.

The present invention can thus provide a simple to use, easy to handle box or box-like container solution that provides a container of high thermal and mechanical insulation for single-use scenarios. Importantly, a substantial benefit, in a cellulose embodiment, is that the product is readily identifiable as a “green product”, being made from natural resources and is readily decomposable.

### BRIEF DESCRIPTION OF THE FIGURES

For a better understanding of the present invention, reference will now be made, by way of example only, to the Figures as shown in the accompanying drawing sheets, wherein:—

FIG. 1 illustrates graphically the temperature-pressure-state of water and carbon dioxide;

FIGS. 1a, 1b illustrate, respectively, perspective views of a first type of container to which the present invention pertains and a known insulation system;

FIG. 2 illustrates a first embodiment of the invention in section being a carton;

FIGS. 3a-3c show three views of an embodiment of the invention indicating aspects of construction of the first embodiment of the invention;

FIGS. 4a, 4b show first and second sectional views of the construction of a layer of the insulator in accordance with the present invention;

FIG. 4c shows a plan view of a layer of the insulator medium in accordance with the present invention;

FIGS. 5a-5c show a roll of insulator sheet in accordance with the invention;

FIGS. 6a-6c indicate how thermal losses are minimized with respect to the insulator sheet in accordance with the invention; Table 1 compares recyclable packaging materials in terms of specific λ values;

FIGS. 7a-14b show the condition of various forms of carton before and after a period of use;

FIGS. 15a, 15b show a second embodiment of the invention.

Table 2 lists the results of tare and net weights in relation to various exemplary equivalent cartons and of their time to bridge two 20° C. temperature ranges;

Graph 1 displays the various temperature changes associated with the various types of carton as indicate in Table 2; and,

Graphs 2-4 display several comparative temperature versus time profiles for various exemplary cartons of the prior art and the present invention.

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific.

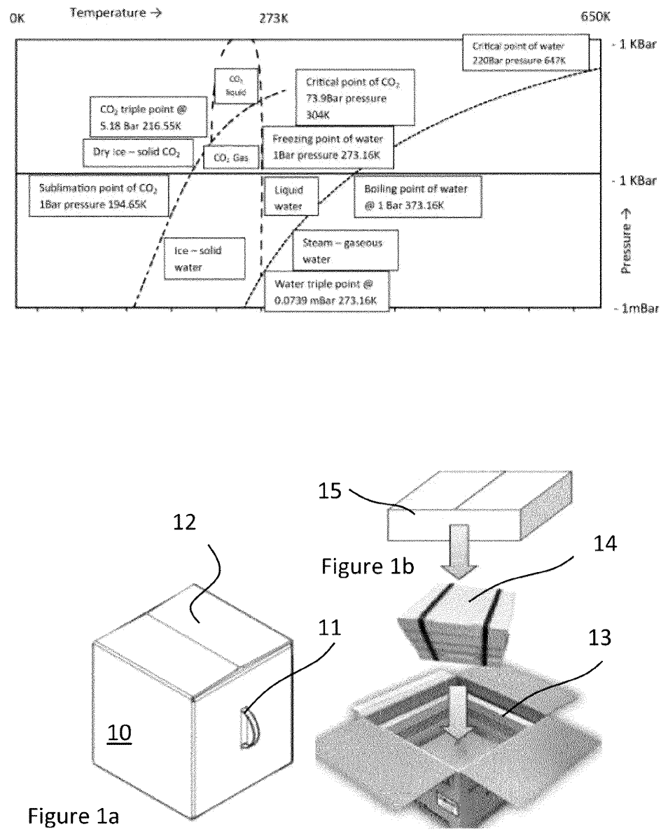

Referring to FIGS. 1a and 1b, there is shown an example of a typical carton as used in the cold chain, for example, for vaccine distribution, delivery of medicaments or e-grocery delivery. The cartons can be arranged so that they retain product within a selected temperature range e.g. within 2-8° C. for up to 120 hours. FIG. 1a shows a carton 10 which is provided with handles 11, having a upper foldable lid panels 12 which enable contents to be placed within and removed from the carton. Insulation panels 13 are provided about the inside walls of the container, being manufactured, for example from expanded polystyrene. It will be realized that the effective volume for the load, together with the necessary temperature control elements 15 means that the load volume is actually deceptively small: the load volume is typically 24 litres even though the dimensions of such a carton are 40×40×45 (W/D/H, in cm), displacing 72 litres. FIG. 1b shows how a load packet 14 is placed within the carton 10 upon which a temperature control unit 15 is placed, with vacuum insulation panels 13 lining an inside of the carton.

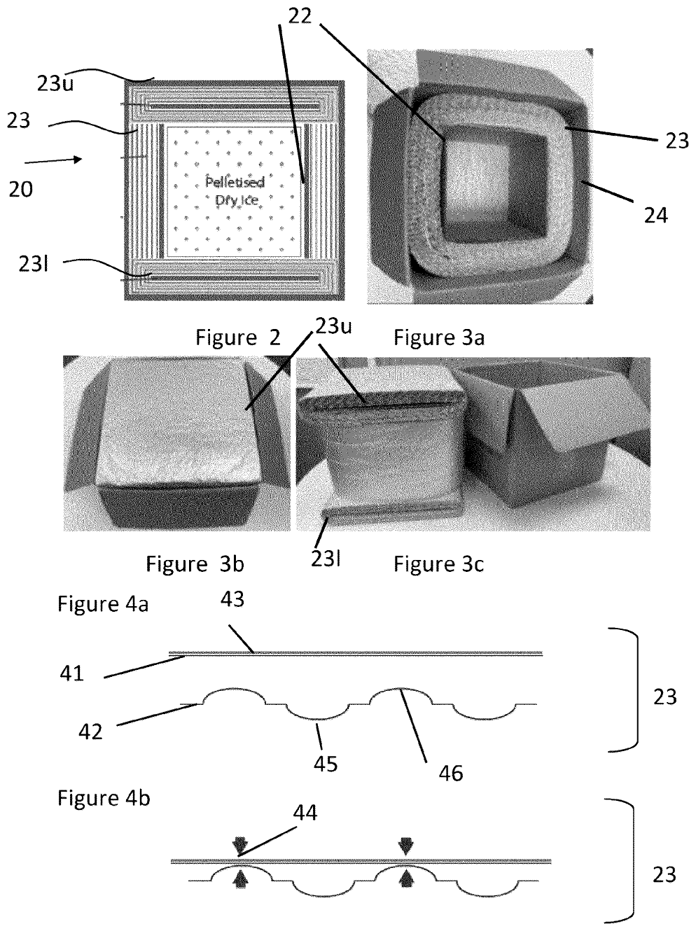

Applicant Company, conscious of the issues of the need to develop recyclable yet efficient products and materials have developed lightweight film comprising at least a first thin film sheet and a second three-dimensional thin film sheet which sheets are coupled together and, preferably, at least one sheet is metallized. Multiple layers of these sheets are employed to define a thickness—for a carton as shown in FIG. 1a—conveniently in the region 1 to 4 cm, noting that an increase in the number of layers of insulation will necessarily increase the overall thermal resistance of the insulation. FIG. 2 shows a schematic section through a first carton in accordance with the invention. Winding 23 comprise wound sheet material wrapped around the vertical walls 22 of an inner compartment for placement of payload whilst windings 231 and 23u comprise closure elements. Within the load volume thermal exchange elements such as PCMs, dry ice etc can be placed. It will be appreciated that, in use, the base of the carton has a lower closure member 231 initially placed therein, the windings and former 23 (to conveniently define a load volume) are then placed—with a thermally sensitive load placed therein, appropriately thermally conditioned prior to placement, together with any dry ice, phase change materials or other form of coolant, followed by placement of the upper closure member 23u. It has been found that the upper and lower closure members can be simply formed by wrapping the two layer insulation film about a cardboard or other simple low thermally conductive sheet former 23f; given that the two ply material is wound around the former it will tend to resiliently bow outwardly from the former; whereby in use the former will inherently seal when placed within the carton, noting that the inside depth of the carton will be configured to correspond to the height of the load volume and winding plus the thickness of the upper and lower closure members. That is to say, upon closure of the carton flaps to close the box, it has been found that it is not necessary to provide further fasteners as between the internal insulation components, albeit, it would be good practice should a mishandling event occur. FIGS. 3a, 3b and 3c, show, respectively, in perspective views from above: a carton with the insulation about the walls and the base visible, with the upper lid flaps 12 folded away outwardly and downwardly; a carton with the upper insulation 23u in place, with the upper lid flaps 12 folded away outwardly and downwardly; and the stacked base, side and upper insulation elements 231, 23 and 23u placed outside a carton.

The carton 20, similar to carton 10, is a standard carton and is conveniently manufactured from cardboard as is ubiquitous in the industry although it is not restricted to being manufactured from such material. The carton is provided with outside walls 11 which are parallel with a central axis of the carton; the insulation insert 23 is aligned with this axis. Whilst not restricted to such operation, it is generally accepted to open such cartons from the top; indeed, when using dry ice it is preferable to prevent spillage of dry ice in use, which can easily cause cold burns or worse, and personnel should always use appropriate gloves and protective eyewear. The upper and lower closure panels 23u and 231 comprise the same layered material as the wall insulation material, conveniently wrapped abut a thin sheet of card to provide a former and can merely be placed below and above the generally cylindrical walls and can be seen to operate as bungs, and may be provided with a central reduced area section, not shown, corresponding in plan with the plan of the inside wall of the insulation insert to enable the wall 24 to engage therewith whereby to provide a further degree of stability, noting that the walls are fragile to a degree and positive location will assist in maintenance of the central payload area to remain in position despite, for example, when the carton is in a delivery van and it is not sufficiently securely retained slides from side to side.

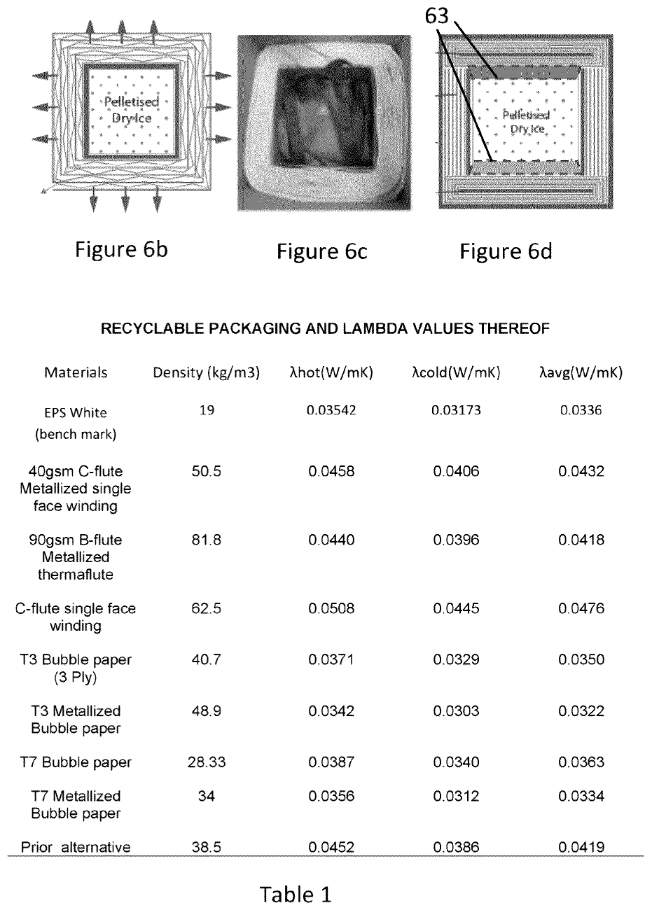

The end members, closures or bungs 23u, 231 can be provided with a further insert component to engage within the inside walls 24, whereby to provide additional thermal security and can provide a greater mechanical resilience since each of the axial ends of the container are less liable to be deformed, noting that the nature of the insulation material is less substantial than, for example, b-flute cardboard. The reduced area inserts 64—as shown in FIG. 6d, conveniently, could be manufactured separately and adhesively secured to a central part of an inside face of the outer bungs 231, 23u, the reduced area inserts conveniently fitting with an interference fit. The nature of the insulation material allowing a good gas tight seal to be provided. The insert 22 is shown as a separate member but an inside wall of the winding 23u, 231 may be employed, reinforced as considered appropriate. Whilst this embodiment relates to a tubular container of a square plan section, it will be appreciated that the shape could be rectangular, triangular, circular, oval or some other polygon, which could be problematic with reference to a sealingly configured end cap.

It will be appreciated that if the upper and lower closure elements (or at least one) are arranged as closure bungs each comprise an external component and an internal component; when fitted, the external component extends beyond the tubular wall member and the internal component lies within the tubular member, whereby to assist in maintenance of the shape of the tubular member. Each closure bung each has a dimension orthogonal to the axis in general correspondence with external dimension of the respective tubular wall member and, likewise, the internal component has a dimension orthogonal to the axis in general correspondence with an internal dimension of the respective tubular wall member, whereby the bung prevents a passage of air as between the outside of the box and an interior thereof, by way of an interference fit. The interference fit may be enhanced by the external dimensions (in plan, i.e. orthogonal to the axis) of the axially innermost part of the internal part of the closure bung being reduced relative to the external dimension in plan of the interface zone of the internal part of the closure bung with respect to the external part of the closure bung, whereby to assist placement of the closure bung, when closing the container. In tests, it has been found that a gasket member comprising crepe paper can be employed to confirm such airtightness. It is to be noted that the first and second bungs may be shaped so that they dispense or substantially dispense with the external part of the closure bung, so that, for example, the external part comprises a thin sheet member. Nonetheless, the seal must be arranged to permit off-gassing to enable equilibrium of the pressure inside the load volume and the atmosphere, when, for example, dry ice is used, which sublimes directly from a solid state to maintain temperature.

Applicant Company has experimented with various films for use in the construction of the insulation of the carton. In one sense, an obvious choice is to use plant-fibre based paper given that is ubiquitous in the packaging industry. Indeed, initial prototyping of the insulation insert layers has been performed with cellulose fibre based materials. Conveniently, Applicant Company has found that an embossed substrate, made from thin single face kraft paper which provides air spacing from an insulating point of view and whilst also providing the mechanical attributes of a paper cushion effect to protect goods from a handling issues. This embossed paper is known from its use in products such as premium chocolate boxes, where it is used as a spacer between layers. Such embossed paper is typically produced in 75 m-long rolls in standard widths of 1,200 mm, 600 mm and 300 mm. These characteristics make embossed paper (sometimes referred to as dimpled paper) ideal for general packaging across a wide range of industries: Applicant Company has bonded such embossed paper to a substantially flat paper which has also been coated with a reflective layer—e.g. a vacuum deposition layer of aluminium, with the bonding being effected by the use of a cellulose glue, hot melt glue, acrylic glue, PVA glue or other similar adhesive, Applicant Company has found that the insulation layer, through the use of the embossed paper remains significant flexibility. The reflective metallization can be applied to first or second substrates or both, but the benefits of applying the reflective coating to both substrates provides less of a significant benefit, especially when factors such as weight and cost are taken into account. Typically, generally circular depressions are employed, but such shapes could be elliptical in shape or even frusto-pyramidical, although it will be noted that whilst there is a degree of flexibility in the use of thin paper—of the weight in the region of 25-90 gm⁻², preferably 25-50 gm⁻², it will be appreciated that such shapes are liable to cause tearing of the paper and that changes in contour are ideally gradual. It will be realized that the bonding of a three-dimensional paper to a rectiplanar sheet will also have a strength greater than expected given the use of the shape. As will be appreciated, the product is 100% biodegradable, noting that vacuum deposition/sputter coating of metals provided sufficiently thin coatings which do not compromise overall recyclability-typical vacuum deposition systems can deposit layers in the range from a thickness of one atom upwards, whilst perfectly good results have been achieved employing 40 gm⁻² metallised paper—calculated to be 34 kg/m3.

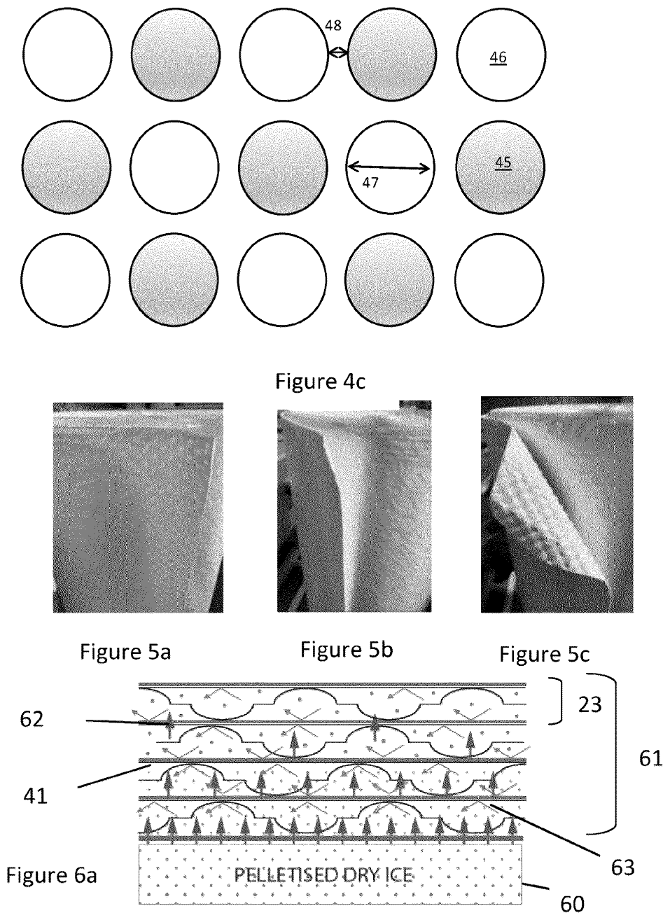

Referring now to FIGS. 4a and 4b, a first example of a type of insulation material 23 is shown, respectively prior to and after joining. Laminate layer 23 comprise a first recti-planar substrate sheet 41 that is provided with a metallized coating 43 on a first side and a three-dimensional sheet 42; the two sheets being attached together by means of an adhesive 44. FIGS. 4a and 4b being the corresponding pre- and post-adhesive arrangements The resulting three-dimensional laminate sheet is employed in the manufacture of the upstanding walls of the carton as described with reference to FIGS. 2-3c. The three dimensional sheet material 42 can be formed from a number of materials, with the embossed features all directed in one direction or, conveniently, alternating between first and second directions from a major plane of the substrate. Conveniently it is wood based; embossed or dimpled paper is known from paper packaging systems—such as those used in the confectionary packaging industry, the dimple structure providing a strength exceeding a simple flat sheet—yet it can be easily formed and folded whilst providing a degree of cushioning in use. Indeed, it has been found that the dimpled paper is appreciable anisotropic and does not suffer from an axial bias in strength arising from the fluting of corrugated paper and board which is of benefit in providing suitably rigid boxes, but is inconvenient when wrapping items.

FIG. 4c shows an array of upstanding circular embossments 45 and corresponding circular depressed embossments 46 relative to a base plane of the embossed paper. The diameter of the circular embossments 47 can be in the range of 3-20 mm, preferably 3-10 mm with the spacing 48 between adjacent upstanding elements and depressed embossments can be in the range of 1-7 mm with the height (trough to peak) being in the range of 1-5 mm, noting that the peak cannot be too great, since there will be a bend caused upon embossment at the rim of the depression/upstanding element which cannot be too sharp—or otherwise the structure will be compromised upon being created—typically using adjacently placed, correspondingly shaped rollers, as is known using a system not too dissimilar to the formation of corrugated flutings as used in the manufacture of corrugated cardboard. In the use of a specific set of embossments, particularly favourable results have been achieved using non-varnished 40 gm⁻² Kraft paper with a diameter of 5-7 mm and a spacing between adjacent troughs/depressions being 7-9 mm with a height of 2-6 mm, more particularly a diameter of 6 mm with a spacing of 8 mm and a height of 3 mm. Of course, the X-Y arrangement as shown in FIGS. 4a-4c, may be oblique. The Kraft paper was metallicized prior to embossment—although the metallization can be performed subsequent to embossment, it will be appreciated that, generally the evaporative deposition of a metal—typically aluminium given that such processes are widely employed; in contrast to general expectations, the metallization will provide 0.05 gm⁻² to the overall weight of a paper sheet i.e. approximately 0.1%, even when of a weight such as 40 gm⁻²—the thickness of metallization will be of the order of 5 Å or so. In a preferred use of kraft paper, counterintuitively, it is better to use bleached kraft paper. This is because when a bleached aluminized kraft paper is recycled by way of, for example, the Ingede recycling process, the efficiency of the process is improved in the event that the paper has been bleached. Applicant believes that the use of unvarnished paper provides an advantage when the system of the present invention is used with dry ice as the passive refrigerant. As is known, the solid carbon dioxide sublimes creating a significant volume of gas, which must be permitted to escape. Whilst not desiring to be restricted to this theory, it is believed that by applying the metallization directly to paper, a sealed volume is not provided; rather the porous 20) nature of the paper permits passage of gas from an internal load volume unit.

Inventors have determined that embossed paper-comprising white virgin paper having a grade of up to 160 gm⁻², preferably 25-90 gm⁻², has produced good results, noting however that the embossed nature provides a nominal thickness in a range from 0.5-20 mm, varying upon the degree of the embossing performed (distance of peak-trough/peak-peak dimensions). Ideally the embossing is established such that the embossed features are arranged alternatively into and out of the paper; whilst the embossments could all be arranged in one direction, one would effectively lose about half of the spacing benefit. Inventors have employed, in respect of the backing paper, a kraft paper of 20-80 gm⁻² but it could also comprise the same type of sheet as the embossed sheet—although it should be noted that in view of the embossing process, and as indicated above a thicker sheet is preferable. The backing sheet can also have aluminium deposited thereon. The thickness of backing paper can be in the range of 0.04-1 mm, preferably in the range of 0.02-0.05 mm, noting that thickness of paper selected will typically increase with area of coverage. That is to say the flat sheet or undimpled paper can have a corresponding thickness to the dimpled paper either prior to or subsequent to the aluminium coating process). The embossed paper can be attached to the backing paper using standard adhesives as widely known in the paper industry, as commonly used for the manufacture of corrugated cardboard, for example, namely water soluble glues, starch based glues, acrylic glues, hot melt glues etc. As is well known, the outer container of the embodiment of FIGS. 2 and 3 is conveniently manufactured from corrugated cardboard, manufactured from plant cellulose, with the flutes of the corrugations extending in general correspondence with the axial dimensions, whereby to provide excellent axial strength. However, other forms of enclosure can be provided such as using recyclable plastics films, boxes with e.g. two compartments, whereby one compartment can be at a specific temperature or each compartment being maintained at a distinct temperature to an external atmosphere.

Despite the increasing awareness of recycling, specific issues may arise whereby fully plant-fibre based recycling facilities are not available or have the capacity to deal with an operator's waste product. Accordingly, Applicant Company has have investigated commercially available fully soluble, biodigestible barrier polymers, which can be applied onto paper, for example as an extrusion coat, providing additional benefits including, to a degree, oil and grease repellence/resistance properties. The types of polymers that are presently being developed comprise polyhydric polymers, particularly polyvinyl alcohol (PVOH materials). Additionally such paper-polymer sheets also provide gas barrier properties and certain paper strength properties, notably properties relating to tear, burst, puncture and tensile strength. Consequential benefits arise from the ability of such sheets to be heat-sealed, assisting in the adherence of a three dimensional film to a planar film. The polymers have been found to demonstrate non-toxic, marine safe properties upon dissolution and biodegrade without forming micro-plastics. Indeed, biodigestible barrier polymers can be engineered to dissolve at specific temperatures, for example the temperatures typically sustained (for a particular processing period) presently employed by high volume recycling mills allowing fibre to be dispersed to make new paper. Polyvinyl alcohol is commonly made by hydrolysis of polyvinyl acetate. The degree of hydrolysis affects the properties of the polymer. Polyvinyl alcohol having a low degree (LD) of hydrolysis, 88% and below, is widely used in industry. Film produced using PVOH materials reacts to water at controlled temperatures typically between 40-70° C., which makes it far more robust in ambient temperatures and therefore functional in packaging applications. PVOH materials can be of the order of three times the strength of polyethylene at the same thickness of film.

FIGS. 5a, 5b and 5c demonstrate the fact that the insulated sheet in accordance with the invention is flexible and can be industrially manufactured into a wound product and be easily transported to manufacturing sites for placement about cartons and for the folding process as has been discussed with reference to FIGS. 2, 3a-3c, above. The spiral roll of layered insulation sheet material is conveniently formed by rolling layered insulation sheet material sheet about a former, with a width of the layered insulation sheet material corresponding with the desired axial length of the tube to be created. The former can have a sectional shape in correspondence with the internal dimensions of the desired shape, be it a simple square or rectangular cylinder, an elliptical or circular cylinder. It will be appreciated that products in general, especially pharmaceutical products, will normally be packaged within rectangular prism cartons, and thus the former is ideally displaces a cuboid volume, noting also that in the transport of low temperature product, space must be provided for the temperature maintenance media. In any event, when assembly the load volume, using a former, by shaping the spiral winding about a former, in the case of a shape having sharp angular changes about a corner, as in the case of a triangular former or other polygonal former, then the initial layer about the former benefits from the creation of well-defined creases, to assist in the subsequent insertion of a plug, when being assembled for use. It has been found that it is sufficient to apply liquid adhesive of a suitable type to engage with the material of the insulation sheet in only a few strategic areas upon the outside of the first sheet of the roll whereby the subsequent spiral sheet becomes adhesively engaged.

In a first alternative, adhesive tape can be applied so that it lies along an initial edge of the insulation material 23, with half of the tape adhering to the edge; the other half to attach to the inside of the winding at the end of the first wind. Glue and tape may be used, as indeed may other fastening means noting that certain fasteners such as staples and the like are to be avoided since their use would compromise thermal characteristics. By applying adhesive to the leading and trailing edges of the roll and between layers, in selected places, the roll of insulation material can retain its overall shape so that the closure elements can readily be placed inside or about the respective first and second apertures of the tube. It would also be possible to apply a tape such as a plastics adhesive tape about the edges of the tube once a spiral wall structure has been created, although this would limit any lateral compressibility of the structure in a direction perpendicular to the axis of the tube, it would be beneficial in closing the exposed ends of the winding as shall be discussed below.

Referring again to FIG. 3a, the insulation layers 23 are shown surrounding a cardboard insert. It will be appreciated that the cardboard could be replaced by other materials, but cardboard benefits from its simplicity and provides security to an inside surface to the winding of insulation material, to make the inside of the container more rugged. The cardboard insert could be used to be placed about a former in a method of manufacture of the winding. Similar methods of construction could be employed with the use of an insert 22 as shown in FIGS. 2 and 3a, where it has been found that the former can be a cardboard with parallel edges about which the corrugated material can be wound.

It will be appreciated that first and second closure devices/bungs 23u, 231 required to make the basic container structure can be provided with a further component to engage within the inside walls 24, adjacent the open ends, whereby to provide additional thermal security and can provide a greater mechanical resilience since each of the axial ends of the container are less liable to be deformed, noting that the nature of the insulation material is less substantial than for example b-flute cardboard. Importantly, this figure shows that, prior to use, the structures can take little space relative to the volume for transport or storage these containers can ultimately provide. Whilst this embodiment relates to a tubular container of a square plan section, it will be appreciated that the shape could be rectangular, triangular, circular, oval or some other polygon.

FIG. 6a shows a cross-section from a dry-ice load area 60 through insulation layers 61 comprising four layers of insulation material 23 and indicate a direction of heat transfer 62 and movement of CO² gas reflecting from the metallized layer 63. The layers of insulation comprise the metallized planar film 41 together with embossed sheet 42. The concept indicates how the single faced metallised paper together with the embossed “cup and ball” three-dimensional layer helps to contain the CO² gas from the dry ice within. It has been shown by the use of multiple layers to significantly slow down the rate of heat transfer by conduction and radiation, with the gas barrier surface significantly reducing the rate of gas diffusion through the walls, noting that off-gassing will be necessary as dry ice sublimates. FIG. 6b shows a simplified view of a horizontal section through the walls of the inside of the carton. FIG. 6c shows a carton with the upper bung 23u removed and thermal temperature leads and their associated temperature probes placed upon a base bung 23l (not shown), as have been used in testing as shall be discussed below.

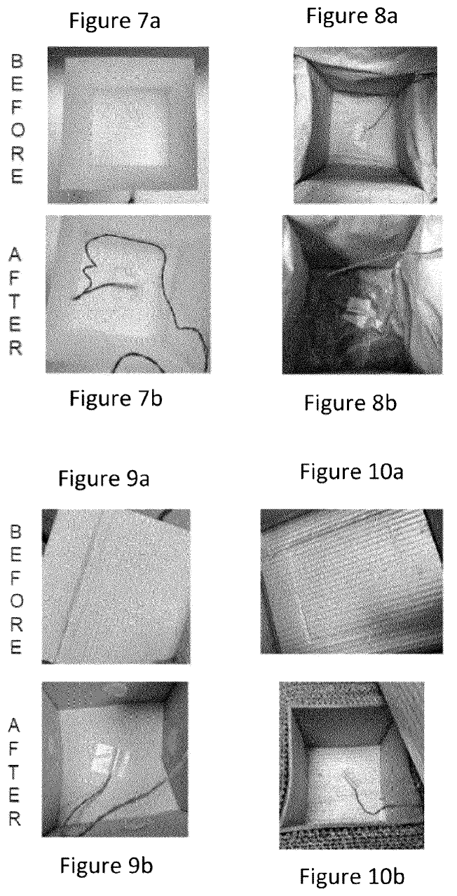

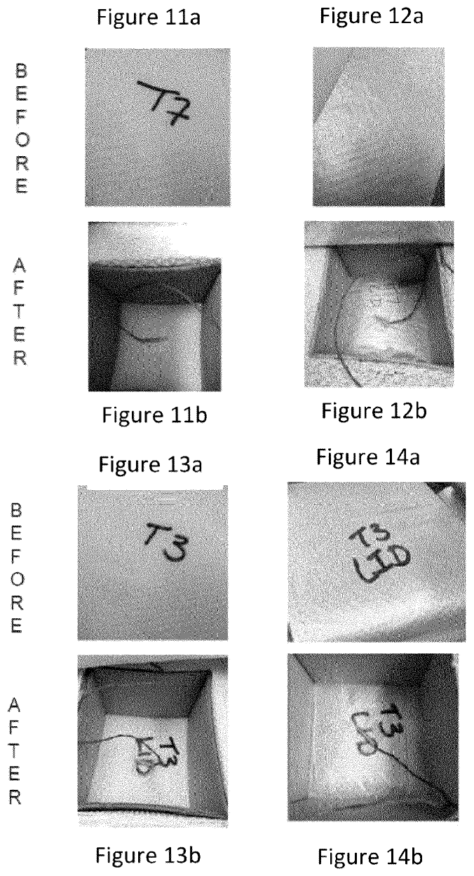

Referring now to Table 1 and FIGS. 7a-14b there are shown photographs of pre- and post-dry ice test for eight types of insulation materials. Per FIG. 7a, the insulator under test was expanded polystyrene and after the testing was largely dry, with only a few drops of water per FIG. 7b. Per FIGS. 8a, b, the insulator under test was a commercially available paper-based product; in contrast to the EPS system, puddles of water and a soaking of the semi-absorbent paper were indicated; With reference to FIGS. 9 & 10, the insulators under test was an unmetallized and metallized versions of a four layer cardboard product available from Applicant; the initial results showed that both were essentially dry, albeit the metallized product tended to absorb less water; in each case the liner warped slightly due in part to ingress of water condensate and in part to poor prototyping. Per FIGS. 11-14, the insulators under test were, respectively unmetallized and metallized wide and narrow spaced embossed insulation sheets. The results showed that the products remained substantially dry, with a small degree of wrinkling of the metallised sheets, meaning that there was little transfer of air from the atmosphere with regard to the inside due to poor isolation as provided by the insulation windings and by the seals between the components, noting that the water absorbed and/or pooled is derived from the atmosphere surrounding the cartons when under test. It is notable that the Lambda value of the material identified as T7 metallized embossed “bubble-like” paper in accordance with the present invention is 0.0334, lower that the Lambda value of the less recyclable but ubiquitous expanded polystyrene 0.0336, as determined using the same apparatus.

With reference to Table 2 and Graph 1, it is apparent that papers in accordance with the invention, once metallized provide superior thermal resistance to products as previously employed such as expanded polystyrene. It is to be noted that the graph does not show the initial 36 hours of the testing, noting that all tests started at −80° C. Metallization appears to improve the thermal insulation duration by some 12 hours or more. The prior systems (unmetallized) could not remain below −20° C. for much more than forty hours, which metallized insulation in accordance with the present invention exceeded sixty hours below −20° C. Indeed, both metallized version of the present invention exceeded the bench-mark performance of expanded polystyrene by six hours, which is significant.

In a second set of tests, per Graphs 2, 3, 4, a period of testing was undertaken—over twelve hours—in accordance with a proprietary pharmaceutical company's summer profile, which is undertaken to indicate the behaviour of an insulator when reacting to ambient air from 22° C. (1-6 hour) to ambient air from 40° C. It is to be noted that the bold line of each group represents the major parcel whereas the lighter and dashed lines are the tolerances of the σ. In this test, it is clear that expanded polystyrene provides a better result that a proprietary insulator. A strong thermal insulation performance is indicated by small gaps between the main line and the tolerances, i.e. the smaller the gap the better. Graphs 3 and 4 each compare the performance of expanded polystyrene insulated carton with one insulated by an insulator of the present invention, one plain insulation, the other metallized insulation, in accordance with the present invention. In Graph 4, the metallized paper shows consistently improved performance to the EPS especially in the 8^{th} to 12^{th} hour of the testing.

In the event that the coiled three-dimensional sheet in accordance with the invention is retained within an outer corrugated cellulose/cardboard carton, it is to be noted that a structural strength of such corrugated cellulose is derived from the physical fluting of the corrugations, which are glued to paper board. Several types of flute are available: typically, single wall corrugated for outer containers will typically incorporate either: R, E, B or C flute. Corrugated cellulose is a natural, environmentally friendly material with an unbeatable record for recycling and recovery. Corrugated cellulose is an extremely flexible medium that accommodates a wide range of printing options to fully support the end user requirements. Additionally, corrugated cellulose can provide a hygroscopic wall, which is of advantage when a cold body increases in temperature and is liable to cause moisture within the enclosed atmosphere to condense; the excess condensation can be absorbed by the cellulose. Corrugated board is made from papers made up from cellulose fibres, which are virgin or recycled and offers almost unlimited possible combinations of board types, flute sizes, paper weights, adhesive types, treatments and coatings. Most types of “cardboard” are recyclable. Boards that are laminates, wax coated, or treated for wet-strength are often more difficult to recycle. Clean cardboard (i.e. cardboard that has not been subject to chemical coatings) is usually worth recovering, although often the difference between the value it realizes and the cost of recovery has been marginal, although with, inter alia, increasing transport costs waste cardboard is becoming increasingly valuable.

Corrugated plastics are generally provided in the form of extruded polypropylene, whereby to provide a lightweight, rigid plastic sheet that is easy to handle. Polypropylene can be simply printed upon using standard techniques and so an external face of a corrugated carton can provide information and/or bear advertisement for a supplier etc. Polypropylene has good chemical inertness and good resistance to cracking under stress, is considered as being inert and there are no widely available solvents operable at 20° C. Furthermore, polypropylene is very resistant to mineral and organic products and is neither affected by water solutions of mineral salts, nor by chemical bases and mineral acids at temperatures lower than 60° C., except very strong acids.

By the use of polypropylene for the manufacture of corrugated board, a number of recycling opportunities are available. Polypropylene can be thermally recycled (incinerated) where the heat produced can then be used as substitutes for oil, gas and coal or to generate energy at power plants. The complete combustion of polypropylene with air only produces carbon dioxide and water. At higher temperatures traces of nitrogen oxide can be generated, whilst the incomplete combustion of polypropylene produces soot, carbon dioxide and monoxide, and several carbon, hydrogen and oxygen compounds. Such unburned by-products are also released during the combustion of natural materials such as wood or wool. Polypropylene wastes can easily be recycled by way of mechanical recycling, where waste product is collected, cleaned/separated, milled, melted and extruded in granules in order to be re-injected in other manufacturing processes.

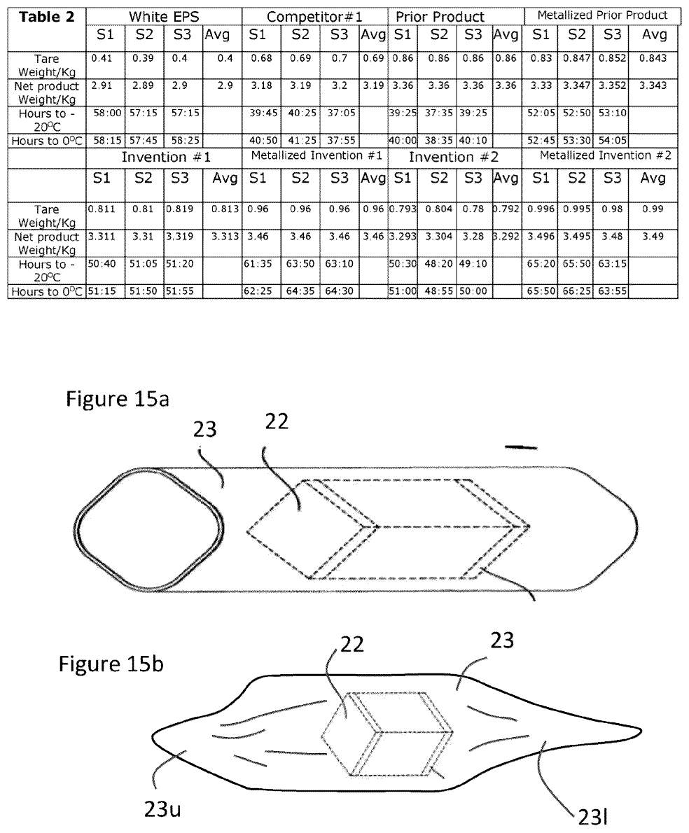

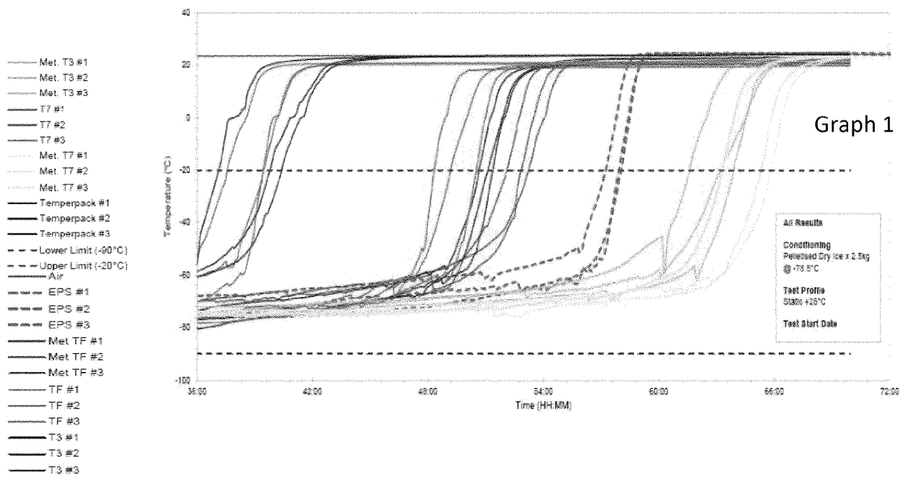

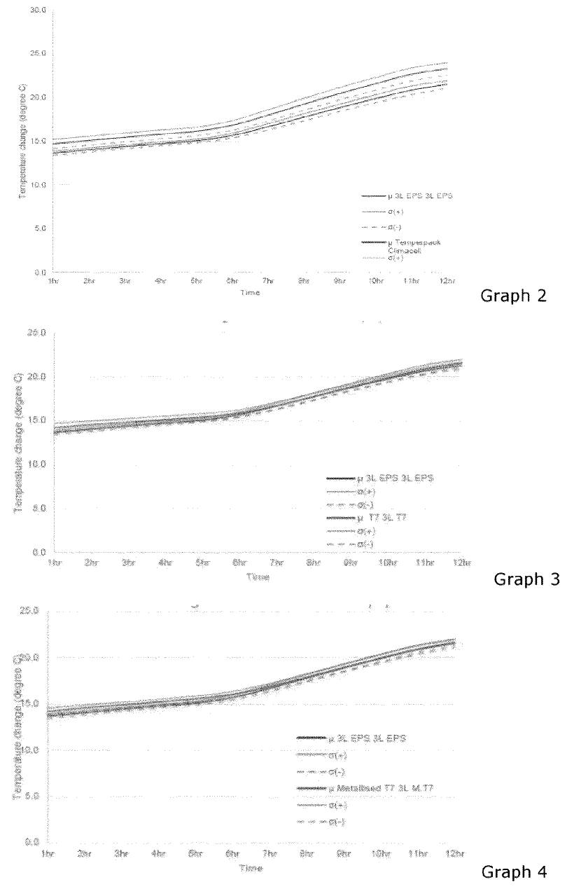

It will be appreciated that the present invention can also provide envelope-wallet thermal insulation packages for posting using mail and courier services. With reference to FIGS. 15a and 15b, there is shown, in outline form a tubular member 23 formed of three-dimensional sheet in accordance with the present invention. The overall length of the tubular element L is greater than the length l of the load volume 22. In this embodiment the excess length of the tubular element is closed off by way of one of a crimping, folding, adhesive fastening, containment within film or a plastic bag or similar, noting that one-way valve apertures for release of carbon dioxide or similar are permitted if dry ice is used as a coolant. FIG. 15b provides a simple representation of what a package can comprise, but the skilled man will realize that multiple variations are possible, noting that the thermal path of the closure element must at least equal that of the layers as provided by the wrapping of the insulation about the load volume. These mailing envelopes whilst typically being slightly bigger than standard courier envelopes due to the number of windings of corrugated material will provide significant benefit compared to standard bubble pack envelopes and much more convenient than polystyrene boxes that have otherwise been employed.

Pharmaceuticals, proteins, biological samples and other temperature sensitive products, including food items, are regularly shipped in containers year round and are subjected to a wide range of temperatures. Though they are shipped in insulated containers and/or climate controlled environments, the temperature stability of the shipping containers can be significantly improved by applying the techniques of the present invention, whereby to provide a simple solution to the maintenance of temperature profiles for the transport and storage of temperature sensitive products. The advantages of using phase change materials for temperature controlled packaging are numerous; the present invention, nonetheless, provides an alternative approach which is both economical and practical for periods of up to 60 hours at low temperatures for standard cartons. A reduction in transportation costs can simply be realised over prior equivalent duration products since less space is devoted to cooling systems, when phase change materials are employed.

1) An insulating transport/storage container for transporting/storing temperature sensitive materials, the container comprising:
a generally tubular wall element defining a load volume between first and second apertures at either end thereof, the tubular wall element having an axis;
first and second closures operable to close first and second apertures; and,
fastening means operable to secure said first and second closures;
wherein the tubular wall element comprises multiple-layers of three-dimensional lightweight film comprising at least a first thin film sheet and a second three-dimensional thin film sheet, with the layers coupled together whereby to define a high level of thermal resistance; and,
wherein, upon securement by way of the fastening means, the closures are brought together with respect to the tubular wall element at the ends thereof about mutually contacting areas.

2) An insulating transport/storage container according to claim 1, wherein the first and second closure elements comprise first and second axially extending portions of the generally tubular element, fastened together to provide a corresponding degree of thermal isolation as the generally tubular wall element about the load volume.

3) An insulating transport/storage container according to claim 1, wherein there is provided a former about which tubular wall elements surround, the former defining a generally tubular assembly having an axis with first and second axially separated apertures and against which, respectively, separate first and second closures abut, to seal therewith.

4) An insulating transport/storage container according to claim 1, wherein there is provided a former about which tubular wall elements surround, the former defining a generally elongate tubular assembly having an axis with an aperture at a first end and a closed axially separated second end, the first closure abutting the aperture to close said first end and the second closure abutting the second, closed end, whereby to provide a uniform degree of thermal isolation about the load volume.

5) An insulating transport/storage container according to any one of claims 1-4, wherein the fastening means comprises one or more of: adhesive tape, tensioned straps, shrink-wrap plastics film, a frame, and a box, wherein the fastening means is operable to ensure that the closure elements fit closely to/abut with the tubular wall element.

6) An insulating transport/storage container according to claim 1 or 2, wherein the three-dimensional lightweight film comprises at least a first thin film sheet and a second three-dimensional thin film coupled together and arranged as a wound sheet or layered sheets, each subsequent sheet surrounding a previous sheet.

7) An insulating transport/storage container according to any one of claims 1-6, wherein the three-dimensional lightweight film is a recyclable sheet material, selected from the group of materials including paper, cellulose-based sheet material and starch-based material that can be embossed or otherwise formed to provide a three dimensional surface.

8) An insulating transport/storage container according to any one of claims 1-6, wherein the separate plies of sheet material of the three-dimensional lightweight film are fastened together by the use of adhesives selected from the group comprising: water soluble glues, starch based glues, acrylic glues and hot melt glues.

9) An insulating transport/storage container according to any one of claims 1-6, wherein the lightweight film has only one sheet that is provided with a metallized surface.

10) An insulating transport/storage container according to any one of claims 1-6, wherein the lightweight film has embossments in the shape of circular or simple polygons.

11) An insulating transport/storage container according to claim 10, wherein the lightweight film has embossments have an effective diameter in the range of 3 mm-20 mm and the height (base to peak) being in the range of 1 mm-10 mm.

12) An insulating transport/storage container according to any one of claims 1-11, wherein the lightweight film comprises sheet material having a backing material of a weight 20-80 gm⁻² and an embossed material having a weight 25-90 gm⁻².

13) An insulating transport/storage container according to any one of claims 1-12, wherein the multiple layers of insulated sheet comprise at least two layers.

14) An insulating transport/storage container according to any one of claims 1-13, wherein at least one of the first and second closures caps define a plug which is operable to fit in an interference fashion with an inside surface of the respective end of the tubular wall.

15) An insulating transport/storage container according to one of claim 3 or 4, wherein at least one of the first and second closures caps are arranged to closely abut the respective first and second ends of the tubular element.

16) An insulating transport/storage container according to any one of claim 3 or 4, wherein at least one of the first and second closures are arranged such said respective closure comprises a first, inner part that has a section that corresponds with an inside section of the tubular wall element associated with one of the apertures and a second, outer part that has a profile that is arranged to provide thermal insulating properties.

17) An insulating transport/storage container according to claim 12, wherein the at least one closure is arranged such that said second, outer part of said closure is arranged such that its section profile corresponds with an external section of the tubular wall element.

18) An insulating transport/storage container according to claim 1, wherein the external part of at least one closure element is arranged such that it is countersunk with respect to the windings of the wall of the container.

19) An insulating transport/storage container according to any one of claims 1-9, wherein a second, outer part of at least one closure element is arranged such that its profile in section extends beyond an external section of the tubular wall element.

20) An insulating transport/storage container according to any one of claims 1-6, wherein a second, outer part of at least one closure element is arranged such that its axial profile extends beyond an the tubular wall element.

21) An insulating transport/storage container according to any one of claims 1-20, wherein the closure elements are retained in place by virtue of being placed in a container which prevents axial movement of the closure elements with respect to the tubular element.

22) An insulating transport/storage container according to any one of claims 1-20, wherein the closure elements are retained in place by at least one of: straps arranged around closure elements and the walls, adhesive tape, adhesive or shrink-wrapping, whereby axial movement of the closure elements with respect to the tubular element is prevented.

23) An insulating transport/storage container according to any one of claims 1-22, wherein the closure elements is formed of a multi-layer corrugated sheet.

24) An insulating transport/storage container according to any one of claims 1-22, wherein the corrugated sheet is cellulose-based wherein layers of sheet and fluted corrugations are glued or otherwise connected to each other.

25) An insulating transport/storage container according to any one of claims 1-22, wherein the corrugated sheet is cellulose-based the corrugated sheet can be formed of a thermo-plastics material, such as polypropylene, which is manufactured in an extruded form.

26) An insulating transport/storage container according to any one of claims 1-25, wherein there is further provided a gasket member to ensure complete sealing with the closure members.

27) An insulating transport/storage container according to claim 26, wherein the gasket member is one of a cellulose based product such as crepe paper or a rubber based product.

28) An insulating transport/storage container according to any one of claims 1-28, wherein the sectional shape of the tubular member is continuous and is one of a square, other rectangular, circular, oval, triangular and other polygons.

29) An insulating transport/storage container according to any one of claims 1-23, further comprising one or more temperature control packs for placement within said insulated container.

30) An insulating transport/storage container according to any one of claims 1-29, wherein the multi-layered corrugated sheet tubular wall member has two or more sections along its axial length where the number of layers of corrugated sheet differs, whereby the R-value varies along the axial length.

31) An insulating transport/storage container according to claim 30, wherein there are two or more internal sections, where the additional internal layers of corrugated sheet define a step, whereby an internal division member can be placed.

32) A method of packing a product for shipment employing an insulation transport/storage container in accordance with one of claims 1-31, the method comprising the steps of:
a. obtaining a tubular insulated sheet container element and arranging the tube so as to define an axial tubular volume;
b. placing a first closure element at a first end of the tubular container element, such that an insert member is associated with the tubular element without gaps as between an inside of the tube and the sides of the insert member;
c. placing product within tubular load volume;
d. placing a second closure element at a second end of the tubular container element, so as to close the tubular load volume; and
e. fastening the tubular member with respect to the first and second members by the use of adhesive fastening means, such as tape (adhesive or otherwise), straps, adhesives, shrink wrap materials or placement within a large box being dimensioned to prevent axial movement/separation of the closure members with respect to the axial tube.

33) A method of packing a product for shipment in accordance with claim 32, the method further comprising the step of selecting one or more temperature control packs for placement within said insulated cavity.

34) A three-dimensional lightweight film insulating material in accordance with any one or more of claims 1-12.
